(19) United States
(12) Patent Application Publication
(10) Pub. No.: US 2012/0325944 A1
(43) Pub. Date: Dec. 27, 2012

(54) DEVICE AND METHOD FOR THE CONTINUOUS TREATMENT OF MASSES A

(76) Inventor: Axel Knobel, Cerro Azul (BR)

(21) Appl. No.: 13/583,152

(22) PCT Filed: Mar. 16, 2011
(86) PCT No.: PCT/IB11/00555

§ 371 Date: Sep. 6, 2012

(30) Foreign Application Priority Data
Mar. 16, 2010 (CH) CH00372/10

(51) Int. Cl. A47J 43/04

(52) U.S. Cl. 241/25; 241/207; 241/206; 241/179; 241/27

(57) ABSTRACT

The invention relates to a device and a method for processing milling material and masses in continuous processes, in particular the treatment of fat-containing masses. Milling with one swashplate (1) with a fixed plate or two swash plates (1), conching with swashplates (1) and also, as a final process step, tempering and crystallizing by means of swashplates (1).

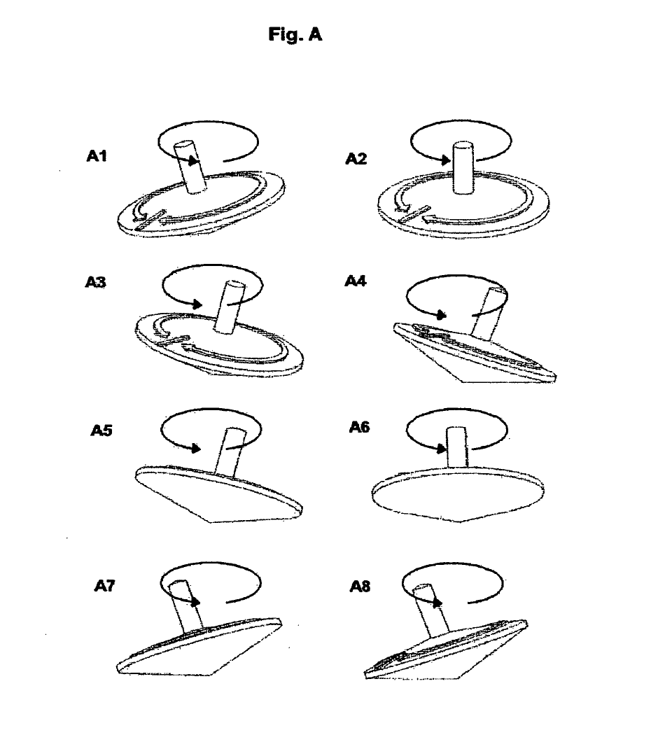

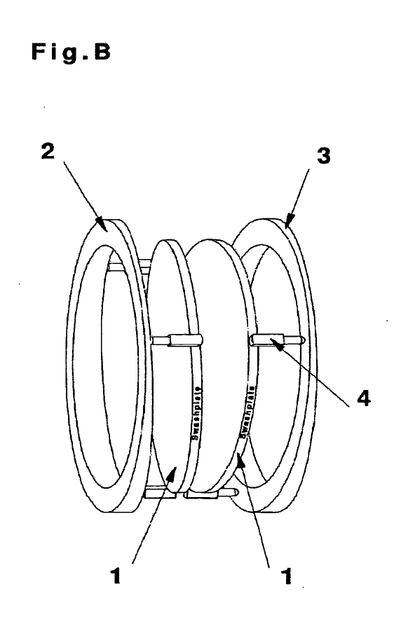

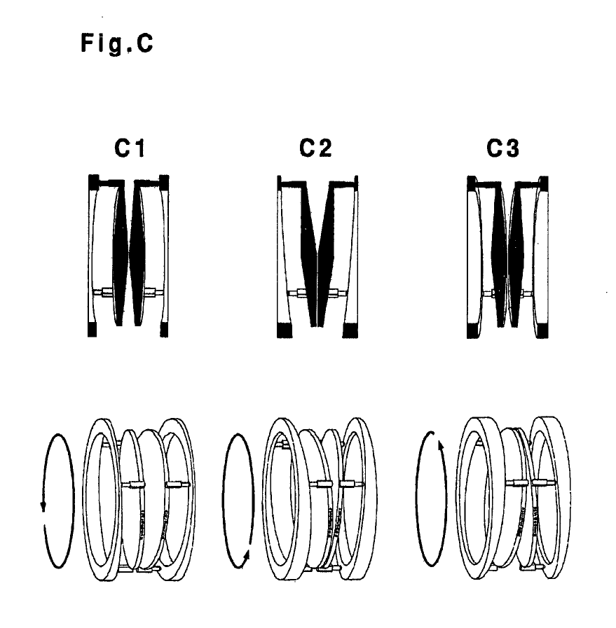

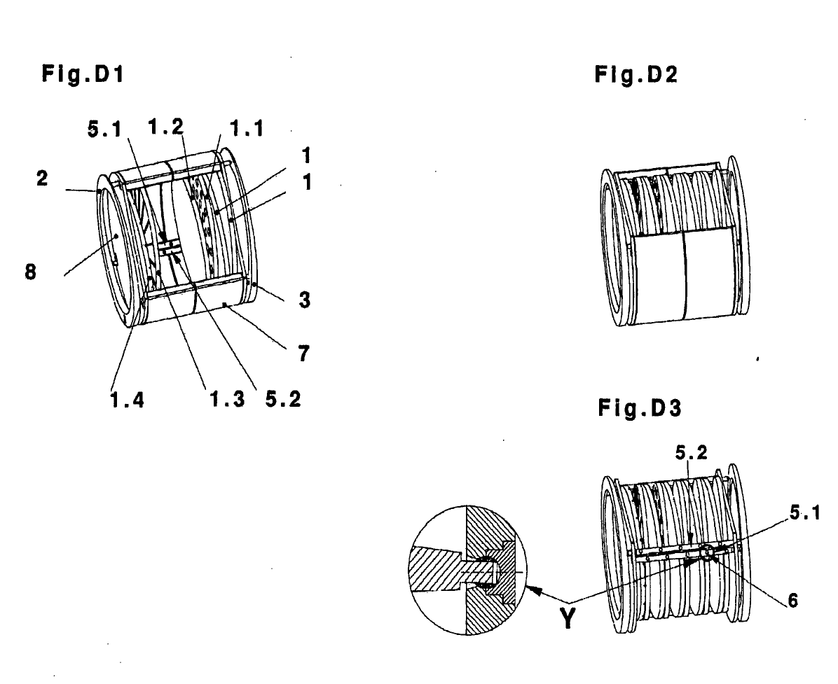

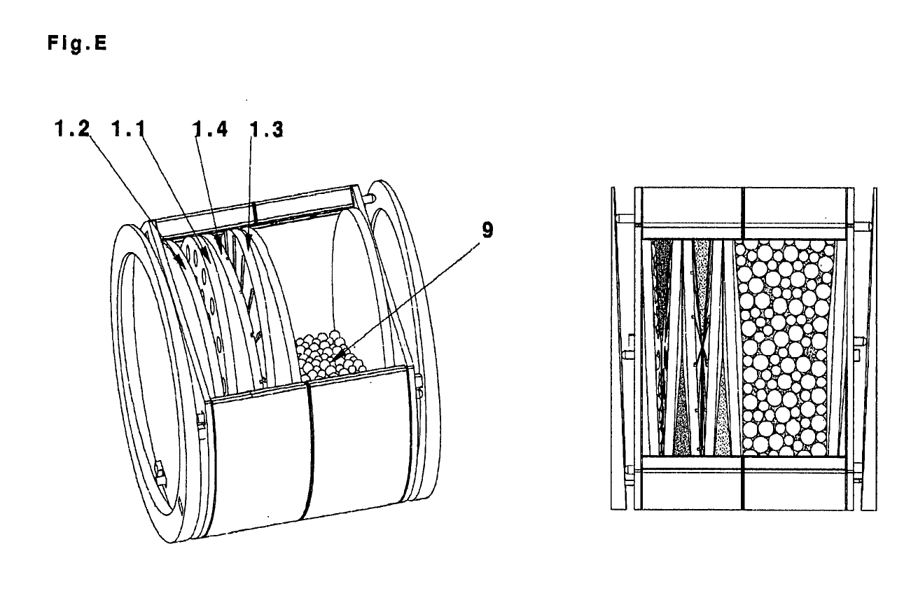

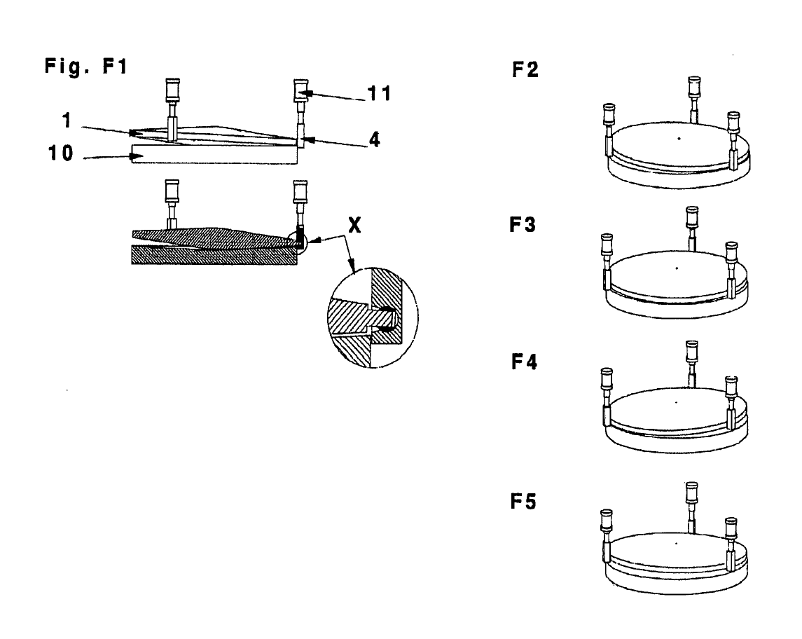

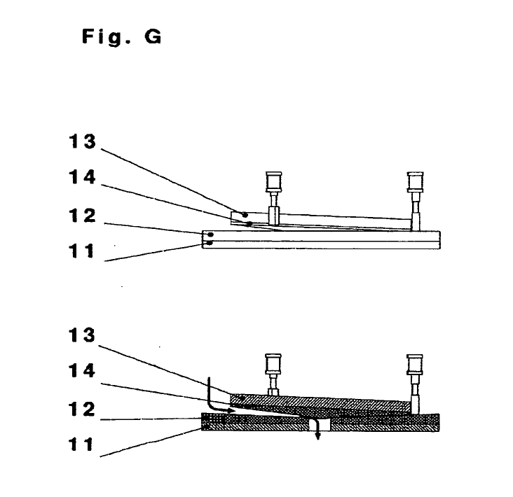

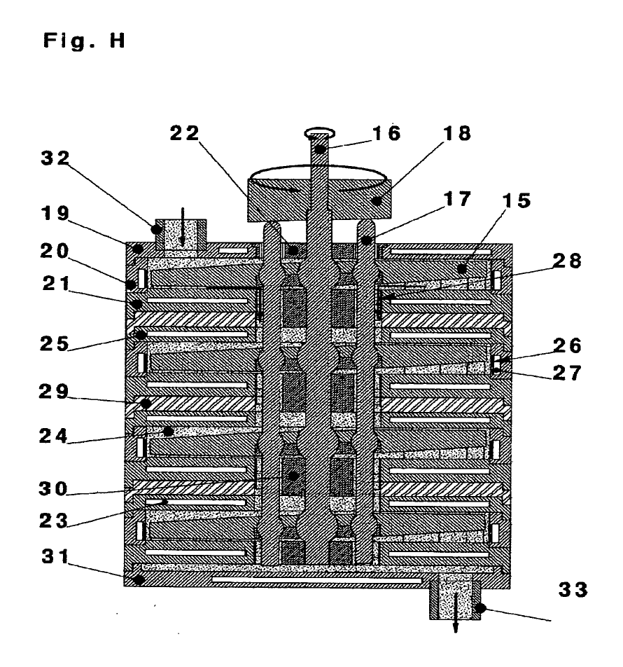

The invention relates to a principle for devices and methods which are used for the processing of masses, in particular chocolate masses. At least one swashplate is used for this principle. The mode of operation of the swashplate is generally known for use in helicopters in order to control rotor inclinations, on the other hand the swashplate is also used in hydraulic pumps.

Tumbling or precession is generally the change in direction of the axis of a body when external forces exert a torque on it. The Euler equations are equations of motion for the rotation of a rigid body. In order to explain the principle of the use of the swashplate for these devices, one can envisage a top which, when it loses momentum, falls onto the plane with the lateral surface of the cone and then rolls around the apex. This rolling around the apex shows clearly the principle of the swashplate used here.

### PRIOR ART

When mixing, comminuting and texturing masses, in particular chocolate masses, conche machines are generally used, which are provided in more or less cylindrical housings and which are provided with rotor(s) which have small scraper, shear and texturing tools in relation to the volume of the mass. The energy inputs are accordingly low. Temperature controls can usually only be achieved via the housing wall and are accordingly difficult and sluggish.

Mills are frequently built for a specific purpose and are not universally usable. The contact time of the milling material in roll mills between the rollers is short, which is why several milling passes are frequently required. The scope for adjustment is small. Usually only circumferential speed of the rollers, friction, milling gap and roller temperature can be adjusted. If these parameters are not sufficient, it is necessary to work with several passes or several rollers. In ball mills or grinding body mills, the energy input is usually introduced by the own weight of the grinding bodies. The grinding bodies and the grinding material are located in a cylinder-like grinding chamber. The grinding speed and the energy input are difficult to regulate.

The various tempering methods and machines will not be discussed here. Merely two methods are mentioned which hitherto have not been related. Firstly there is the method of tabulating, that is hot chocolate mass is spread by means of a spatula on a worktop preferably consisting of marble, until the mass thickens and cools down and crystals are formed. The inoculation method is mentioned as the second method in which the chocolate mass can be crystallized out by means of inoculation crystallization.

### DESCRIPTION OF THE INVENTION

The invention is based on the object of increasing the energy input (mechanical and/or thermal) and the substance input (e.g. gassing) and also the substance removal (e.g. degassing) in a device and a method for processing milling material and masses in order to reach the final state of the milling material or the mass desired by the processing more rapidly than with the conventional prior-art means.

In order to solve this object, the invention provides a device for processing masses, in particular chocolate masses, in which at least one swashplate (1) provided with an obtuse-angled cone on its front side, is disposed so that the apex of the swashplate (1) lies on the axis of the swashplate and the lateral surface of the swashplate (1) can extend as far as its outside diameter, wherein the swashplate (1) is shaped and disposed with respect to a mating surface opposite its obtuse-angled cone such that a line of the swashplate (1) running from the apex over the lateral surface as far as the outside diameter of the lateral surface is disposed parallel to the mating surface and can thus unroll and/or tumble against the mating surface.

In the method according to the invention for the continuous preparation of masses, in particular for the mixing and refining of fat-containing masses, preferably using a device according to the invention, the mass is sheared, textured, gassed, degassed and tempered by means of swashplates, in particular between swashplates.

Advantageous embodiments of the device and the method according to the invention are obtained from the subclaims 2 to 28 or 30 to 34.

This enables, for example, the milling with one swashplate with fixed plate or two swashplates, conching with swashplates and as a last process step tempering and crystallization by means of swashplates. Different arrangements of the swashplates can lead to different variants of the device. Some examples are listed hereinafter.

In a first arrangement the swashplates are arranged so that the lateral surface[s] on the line from the apex to the outside diameter lie on one another, unroll with respect to one another without rotating radially about their own axis. The swashplates are made to tumble by means of cam disks which are connected to the swashplates by means of tumble thrust shafts and are also controlled. The cam disks can be designed to be both mechanically and also servo controlled. The swashplates are placed in a housing so that they are enclosed at the circumference. A cavity is thus formed between the swashplates. This cavity moves around the axial center points of the swashplates. The mass located therein is accordingly always guided around this fictitious axis between the axial center points. If this fictitious axis now lies horizontally and a part of the mass is located in the cavity between the swashplates and the swashplates are tumbling toward one another, the mass is pushed over this fictitious axis. If the movement is sufficiently fast, the mass swashes over. This process promotes oxygen exchange.

Particularly in conche machines for chocolate preparation, several factors are responsible for the rational conching. On the one hand, graining should be avoided which can be reduced by means of shear processes, then texturing is an essential process and a very important substance exchange process (for example, the release and removal of bitter substances). For this purpose the swashplates are provided with geometries which on the one hand show shear effects, and on the other hand promote texturing. Furthermore, geometries which especially promote gas exchange can be used. One of the advantages of this invention compared with conventional known systems is the ratio of these geometries to the volume of the masses to be processed. It is thereby possible to drastically shorten the conching time or be able to increase the quality of the mass for the same conching time. The shear and texturing geometries are selected so that they operate as efficiently as possible, that is, they have the lowest possible energy supply. According to the invention the gas exchange is optimized by the intensive tumbling of the mass over the horizontal axis as well as possible removal of energy which was supplied during the shearing and texturing. Furthermore it is easy to connect the swashplates to a heat balance since the disks tumble and do not rotate. The high contact area of the mass to be processed enable a gentle control of the heat supply and removal. These properties are also used for products, for example, in the chemistry, pharmaceutical and cosmetics industry.

In a second arrangement a swashplate is placed above a horizontal fixed plate. The swashplate tumbles over the fixed plate. The term fixed plate in this connection must be understood such that it does not tumble. It can rotate about its own axis and/or change position. The swashplate is in particular servo-controlled or driven by means of a cam disk. It is thereby possible to make the swashplate tumble so that a function for a mill (milling function) is obtained together with the fixed plate. Compared with many known systems this arrangement has the advantage that more parameters are available for adjustment. Along with known adjustments such as circumferential speed of the rollers (fixed plate), friction, grinding gap and swashplate temperature (roller temperature), it is also possible to run engaging angle, gap angle as well as large and small speed differences. It is possible to make the fixed plate rotate so that, for example, the milling material remains precisely in the working area due to the centrifugal force. However, this can also be achieved by the gap angle. As a result, the milling material can remain in the mill until, for example, a desired grain size is achieved,

In a third arrangement the swashplates are as described under [009] but there is a distance between the lines on the lateral surfaces from the apex to the outside diameter. The space thereby enlarged is filled with grinding bodies or spheres as well as milling material. The grinding bodies or spheres and the milling material are now milled by the tumbling movements of the swashplates. Compared with conventional ball mills, however, use is made of the advantage that more energy can be introduced in a controlled manner with the swashplates. Furthermore, it is possible to couple modules with swashplates for subsequent process steps.

In a fourth arrangement the swashplate is arranged similarly as in [010]. However the swashplate has a central shaft. The tumbling movements are driven by means of tumble thrust rods disposed close to the central shaft. The central shaft is coupled to the swashplate so that this can tumble but is radially fixedly connected. The swashplate can now, for example, be configured so that it also has a scraping function. It is now possible to run a “tabulating program”. The mass is led into the first chamber, partially tabulated, possibly supplied with liquid chocolate mass via the radially disposed feed chamber, passed into the second chamber and so on until the tempered pre-crystallized mass is taken out.

As a second possibility, the pre-mixed inoculation crystals are guided via the feed chambers into the tempering chambers, and intensively processed there at a precise temperature. It is also completely possible to combine both processes. In both processes it is not necessary to return a part of the mass as in other systems. In addition, it is also possible to add ingredients via the feed chambers

### BRIEF DESCRIPTION OF THE FIGURES

FIGS. A, A1 to A8 explain the principle of the swashplate.

FIG. B shows a perspective view of an embodiment with two swashplates.

FIG. C, C1 to C3 shows in section and in perspective view how the swashplates tumble with respect to one another.

FIG. D1 shows the structure of a conche machine with swashplates.

FIG. D2 shows the housing with five pairs of swashplates.

FIG. D3 shows the mounting of the swashplates.

FIG. E shows a housing with swashplates and grinding bodies.

FIG. F1 shows the suspension of a swashplate. The image sequence FIG. F2 to FIG. F5 shows the tumbling of the swashplate over a fixed plate.

FIG. G shows the same principle as described under FIG. F1, but the swashplate is in two parts.

FIG. H shows several swashplates accommodated in a housing.

### DESCRIPTION OF ILLUSTRATED EMBODIMENTS

The principle of the swashplate is explained with the image sequence in FIG. A, A1 to A8. It can be illustrated how the swashplate according to the invention tumbles by means of a simple top rolling on the lateral surface around the tip of the cone.

FIG. B shows two swashplates 1 which are connected by tumble thrust shafts 4 which for their part run on the cam disk right 3 and on the cam disk left 2. The cam disks are arranged symmetrically.

FIGS. C, C1 to C3 shows, in section and in 3D view, however the swashplates tumble with respect to one another, controlled by means of the cam disks.

FIG. D1 shows the structure for a conche machine with swashplates 1, swashplates with negative texturing contours 1.1, swashplates with positive texturing contour 1.2, swashplate with positive shearing contour 1.3, swashplate with negative shearing contour 1.4. These are accommodated in a housing which consists of the housing jacket 7 and the housing covers 8. In this example, the tumble thrust shafts 5.1 and 5.2 are let in the housing jacket. Located on the outside of the housing are the cam disks right 3 and left 2 which drive the swashplate via the tumble thrust shafts 5.1 and 5.2.

FIG. D2 shows the housing with five pairs of swashplates.

FIG. D3 shows how the swashplates are mounted 6 in the tumble thrust shafts 5.1 and 5.2. Detail Y as a section of 6 shows the linear bushing mounting.

FIG. E shows a housing as described under FIG. D1. It is shown here how using two swashplates 1 with a distance between the lines on the lateral surfaces from the apex to the outside diameter, the space in between is partially filled with grinding bodies (spheres) 9 in which the milling material can be ground. Due to the tumbling movements the grinding bodies are milled with the milling material. This milling now brings about the grinding. In this method it is advantageous that energy can be supplied in a controlled manner. As shown here it is possible to subsequently connect further swashplates with negative texturing contours 1.1, swashplates with positive texturing contour 1.2, swashplate with positive shearing contour 1.3, swashplate with negative shearing contour 1.4, where the different processing contours on the swashplate can also be combined with one another.

FIG. F1 shows a swashplate 1 which is suspended on tumble thrust shafts 4 and placed above the fixed plate 10. The tumble thrust shafts 4 are coupled to servo drives 34. The servo drives 34 are controlled by means of an electronic cam disk. Detail X shows a simplified view of the linear bushing mounting. The image sequence FIG. F2 to FIG. F5 shows the tumbling of the swashplate over the fixed plate.

FIG. G shows the same principle as described under FIG. F1 but the swashplate is in two parts. The swashplate upper part 13 is configured so that a swashplate tool 14 can be mounted. The fixed plate lower part 11 is configured so that a fixed plate tool 12 can be mounted. It is thereby possible to use different tools as required. The fixed plate with tool can be larger than the swashplate with tool. As a result milling material can be filled from outside. The milling material can be removed through the central opening.

FIG. H shows how several swashplates can be accommodated in a housing. The swashplate 15 can tumble but cannot turn radially about the central shaft 16. The tumbling movement is effected by means of tumble thrust shafts 17. These in turn are moved by means of the cam flange 18. The swashplate 15 is disposed in the mass chamber 24 so that the line from the apex to the outside diameter is parallel to the upper fixed plate 25 and 19 and parallel to the lower fixed plate 21. The mass is guided via the mass inlet principal flow 32 into the mass chamber 24. The swashplate 15 (can now be configured, for example, so that it also has a scraper function) mixes the mass and scrapes it from the fixed plate at the top and bottom. The central shaft 16 can be turned. This is required for the scraping function. The top and bottom fixed plates can now be driven via the heating/cooling channel 23 at the required temperature. Liquid mass can be supplied via the feed channel 27 and through the mass and ingredient inlet 26. The processed or partially processed mass is conveyed between the mass chambers 24 via passages 28 located in the intermediate ring 30. The individual mass chambers 24 are terminated by the top and bottom fixed plates and by the housing cylinder with feed channel 20 and separated by the intermediate plate 29. After the finish processing, the mass is extracted via the mass outlet 32.

### REFERENCE LIST

1 Swashplate
1.1 Swashplate with texturing contour negative
1.2 Swashplate with texturing contour positive
1.3 Swashplate with shear contour negative
1.4 Swashplate with shear contour positive
2 Cam disk left
3 Cam disk right
4 Tumble thrust shaft
5.1 Tumble thrust shaft right
5.2 Tumble thrust shaft left
6 Swashplate bearing
7 Jacket housing
8 Housing cover
9 Grinding body (balls)
10 Fixed plate
11 Fixed plate lower part
12 Fixed plate tool
13 Swashplate upper part
14 Swashplate tool
15 Swashplate for central shaft
16 Central shaft
17 Swashplate thrust rod
18 Cam flange
19 Housing upper part/upper fixed plate
20 Housing cylinder with feed channel
21 Fixed plate bottom
22 Terminating flange
23 Heating/cooling channel
24 Mass chamber
25 Fixed plate top
26 Mass and ingredient inlet
27 Feed chamber
28 Passage between mass chamber
29 Intermediate plate
30 Intermediate ring
31 Housing lower part
32 Mass inlet main flow
33 Mass outlet
34 Servo drives

1. A device for processing masses wherein at least one swashplate provided with an obtuse-angled cone on its front side, is disposed so that the apex of the swashplate lies on the axis of the swashplate and the lateral surface of the swashplate can extend as far as its outside diameter, wherein the swashplate is shaped and disposed with respect to a mating surface opposite its obtuse-angled cone such that a line of the swashplate running from the apex over the lateral surface as far as the outside diameter of the lateral surface is disposed parallel to the mating surface and can thus tumble against the mating surface.

2. The device according to claim 1, wherein the mating surface is a surface of a second swashplate, wherein the two swashplates provided with two obtuse-angled cones on the front sides thereof, are disposed so that the apexes lie on the axis of the swashplate and the lateral surface can extend as far as the outside diameter and the swashplates are disposed such that lines from the apex over the lateral surface as far as the outside diameter of the lateral surface are disposed parallel to one another and can thus tumble against one another.

3. The device according to claim 2, wherein the tumbling movements are produced via tumble thrust shafts or tumble thrust rods by means of mechanical cam disks or cam flange or electronic cam disks with servo drives.

4. The device according to claim 2, wherein the swashplates are provided with an obtuse cone and that the lines from the fictitious apex via the lateral surface to the outside diameter of the lateral surface are arranged parallel to one another and can thus tumble with respect to one another.

5. The device according to claim 2, wherein at the swashplate, in particular at the swashplate upper part, a fictitious cone or truncated cone is provided on the front faces and that lines from the fictitious apex via the fictitious lateral surface to the outside diameter of the fictitious lateral surface are arranged parallel to one another and can thus tumble with respect to one another.

6. The device according to characterized claim 2, wherein the cone or truncated cone can be arbitrary and the angles of the cones can be arbitrary.

7. The device according to claim 5, wherein the swashplates can be provided with a fictitious cone or truncated cone with a right cone or truncated cones or that the cone or truncated cone in the form of a swashplate tool can be mounted or dismounted.

8. The device according to claim 1, wherein a plurality of swashplates are arranged so that each swashplate is arranged with the next swashplate such that lines from the apex over the lateral surface as far as the outside diameter of the lateral surface are disposed parallel to one another and can thus tumble against one another, wherein the tumbling movements are preferably driven by means of tumble thrust shafts.

9. The device according to claim 1, wherein for processing masses or milling material, the swashplate and the mating surface are disposed at a distance from one another, wherein the space formed by the distance between the two lines is at least partially filled with milling bodies, preferably with spheres, so that masses or milling material can be ground in the space.

10. The device according to claim 1, wherein for processing masses or milling material, two swashplates are disposed with a distance between the lines running on the lateral surfaces from the apex to the outside diameter, wherein the space formed by the distance between the two lines is at least partially filled with milling bodies, preferably with spheres, so that masses or milling material can be ground in the space.

11. The device according to claim 1, wherein the front faces or lateral faces of swashplates are configured with shear formations or shear contours and with texturing formations or texturing contours in such a manner that the formations or contours can intermesh during tumbling of the swashplates.

12. The device according to claim 11, wherein at the same time formations or contours having different functions, in particular for introducing air into the mass are provided, wherein formations or contours with different functions are preferably provided combined with one another.

13-18. (canceled)

19. The device according to claim 12, wherein the swashplates can have scrapers, seals, sealing rings or sliders on the circumference.

20-28. (canceled)

29. A method for the continuous mixing and refining fat-containing masses using a device according to claim 1, wherein the mass is sheared, textured, gassed, degassed and tempered by means of swashplates between swashplates.

30. The method for the processing of masses or milling material, wherein the mass or the milling material is processed between a swashplate and its mating surface or between neighboring swashplates by means of milling bodies, in particular in the form of spheres, whereby the mass or the milling material together with the milling bodies are milled between the swashplate and its mating surface or between the two swashplates.

31-34. (canceled)
